(19) United States
(12) Patent Application Publication
(10) Pub. No.: US 2015/0145826 A1
(43) Pub. Date: May 28, 2015

(54) TOUCH SENSOR

(71) Applicant: SAMSUNG ELECTRO-MECHANICS CO., LTD., Gyeonggi-Do (KR)

(72) Inventors: Tae Kyung LEE, Gyeonggi-Do (KR); Jang Ho PARK, Gyeonggi-Do (KR); Beom Seok OH, Gyeonggi-Do (KR); Deok Seok OH, Gyeonggi-Do (KR)

(73) Assignee: SAMSUNG ELECTRO-MECHANICS CO., LTD., Gyeonggi-Do (KR)

(21) Appl. No.: 14/554,950

(22) Filed: Nov. 26, 2014

(30) Foreign Application Priority Data
Nov. 26, 2013 (KR) 10-2013-0144661
Nov. 14, 2014 (KR) 10-2014-0158922

(51) Int. Cl. G06F 3/044; G06F 3/045

(52) U.S. Cl. CPC G06F 3/044; G06F 3/045; G06F 2203/04112
USPC 345/174

(57) ABSTRACT

Embodiments of the invention provide a touch sensor including a substrate, and an electrode on the substrate. The electrode includes a first diffusion barrier contacting the substrate, an intermediate layer formed on the first diffusion barrier, and a second diffusion barrier formed on the intermediate layer. According to an embodiment of the invention, corrosion of the intermediate layer and performance degradation caused by diffusion may be prevented by forming the intermediate layer on the first diffusion barrier contacting the substrate and forming the second diffusion barrier on the intermediate layer.

### CROSS REFERENCE TO RELATED APPLICATION

This application claims the benefit of and priority under 35 U.S.C. §119 to Korean Patent Applications No. KR 10-2013-0144661, entitled, “TOUCH SENSOR,” filed on Nov. 26, 2013, and KR 10-2014-0158922, entitled, “TOUCH SENSOR,” filed on Nov. 14, 2014, which are hereby incorporated by reference in their entirety into this application.

### BACKGROUND

1. Field of the Invention

The present invention relates to a touch sensor.

2. Description of the Related Art

In accordance with the growth of computers using a digital technology, devices assisting the computers have also been developed, and personal computers, portable transmitters, other personal information processors, as non-limiting examples, execute processing of text and graphic using a variety of input devices, such as a keyboard and a mouse.

In accordance with the rapid advancement of an information-oriented society, the use of computers has gradually been widened; however, it is difficult to efficiently operate products using only the keyboard and the mouse currently serving as an input device. Therefore, the necessity for a device that is simple, has minimum malfunction, and is capable of easily inputting information has been increased.

In addition, current techniques for input devices have progressed toward techniques related to high reliability, durability, innovation, designing and processing beyond the level of satisfying general functions. To this end, a touch screen panel has been developed as an input device capable of inputting information, such as text, graphics, as non-limiting examples.

In addition, a market of the touch screen panel TSP has been expanded due to introduction of a smart device. This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

The touch panel is classified into a resistive type of touch panel, a capacitive type of touch panel, an electromagnetic type of touch panel, a surface acoustic wave (SAW) type of touch panel, and an infrared type of touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

A capacitive type metal sensor uses various kinds of metals and structures, but mainly uses ITO (In—Sn-Oxide), which is a transparent conductive metal, due to visibility, as a non-limiting example. However, indium of the ITO recently causes rise in costs due to a price rise of a rare earth metal, and since the ITO also needs a high temperature process, it has unfavorable requirements if used for a substrate vulnerable to heat. In addition, the ITO is likely to be easily broken due to brittleness thereof. Therefore, a sensor in which the metal is manufactured in a mesh shape (hereinafter, referred to as “metal mesh”) to use as the metal sensor for other conductive metals has been developed.

It is expected that a market of the metal mesh is gradually increased for future use. However, due to high integration of components including the touch sensor, a line width of thin film layers in the components has been further decreased and the thin film layers have been further multilayered. In this situation, many problems are happening between a metal wiring and a substrate including silicon due to diffusion. For this reason, an attempt to prevent the diffusion between the metal and silicon has been continuously performed.

Currently, the touch sensor has been developed using the metal mesh made of conductive metals such as aluminum (Al), silver (Ag), copper (Cu), as non-limiting examples. Among these, in the case in which copper (Cu) is used for the metal mesh, since copper (Cu) has more excellent electrical conductivity than aluminum (Al) and is inexpensive compared to silver (Ag), it has recently become prominent.

However, copper also has disadvantages. Copper has disadvantages that since it is thermodynamically unstable, it is easily reacted with a contact material, is easily oxidized in an oxidizing atmosphere, and has bad adhesion characteristic with most insulating materials. In addition, since copper is easily corroded and has a unique red color, there is a problem in improving visibility of the metal mesh. Further, copper is known as a metal which is best diffused with other medium. Therefore, in order to overcome the above-mentioned disadvantages, a barrier metal is generally deposited on upper or lower portions of a copper layer.

Particularly, in a case of a window integral type touch sensor, the metal mesh sensor is formed on glass containing silicon oxide (SiO₂), wherein reactivity between copper and silicon (Si) may cause a problem. Referring to a graph shown in “Solubilites of 3d Metals in Silicon,” S J. D. McBrayer, R. M. Swanson, and T. W. Sigmon, J. Electrochem. Soc., Vol. 133, pp. 1242-1246, 1986, it may be seen that solubility of copper and nickel (Ni) with silicon (Si) is higher than that of other metals. Further, as the line width is decreased, high temperature is generated, which may accelerate the diffusion. This diffusion causes a specific resistance to be increased and causes reliability of the entire circuit as well as an electrode to be degraded.

In addition, a diffusion coefficient between copper and nickel is also high as compared to other metals. That is, even in a case of a low temperature, inter-diffusion occurs through grain boundary diffusion, which may cause performance degradation. A diffusion barrier capable of preventing the above-mentioned diffusion is required.

### SUMMARY

Embodiments of the present invention have been made to confirm that corrosion of an intermediate layer is prevented and performance degradation caused by the diffusion is prevented by disposing a diffusion barrier, which is a transition metal and has a melting point of 2000° C. or more, on upper and lower portions of the intermediate layer of an electrode of a touch sensor. Embodiments of the present invention have been completed based on the above-mentioned content.

Embodiments of the present invention have been made in an effort to provide a touch sensor capable of preventing corrosion and performance degradation of an intermediate layer caused by diffusion using a diffusion barrier.

Embodiments of the present invention have been made in an effort to provide a touch sensor capable of improving operation reliability by preventing performance degradation caused by diffusion.

In accordance with an embodiment of the invention, there is provided a touch sensor including a substrate, and an electrode on the substrate. The electrode includes a first diffusion barrier contacting the substrate, an intermediate layer formed on the first diffusion barrier, and a second diffusion barrier formed on the intermediate layer.

In accordance with an embodiment of the invention, the first and second diffusion barriers are made of a transition metal.

In accordance with an embodiment of the invention, the first and second diffusion barriers are made of a metal having a melting point of 2000° C. or more.

In accordance with an embodiment of the invention, the first and second diffusion barriers are made of any one selected from the group consisting of manganese (Mn), niobium (Nb), molybdenum (Mo), ruthenium (Ru), hafnium (Hf), tantalum (Ta), tungsten (W), iridium (Ir), and an alloy containing at least one of them.

In accordance with an embodiment of the invention, the first diffusion barrier and the second diffusion barrier are made of the same material as each other.

In accordance with an embodiment of the invention, the first diffusion barrier and the second diffusion barrier are made of different materials.

In accordance with an embodiment of the invention, the intermediate layer is made of any one selected from the group consisting of copper (Cu), silver (Ag), gold (Au), aluminum (Al), and an alloy containing at least one of them.

In accordance with an embodiment of the invention, the substrate is a window substrate or an insulating film.

In accordance with an embodiment of the invention, the substrate is made of any one selected from the group consisting of polyethylene terephthalate (PET), polycarbonate (PC), poly methyl methacrylate (PMMA), polyethylene naphthalate (PEN), polyethersulphone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), and glass or tempered glass.

In accordance with an embodiment of the invention, the electrode is formed to have a line width in the range of 1 to 5 μm.

In accordance with an embodiment of the invention, the electrode is formed to have a thickness in the range of 0.05 to 3 μm.

In accordance with an embodiment of the invention, the first diffusion barrier is formed to have a thickness in the range of 1 to 500 nm.

In accordance with an embodiment of the invention, the second diffusion barrier is formed to have a thickness in the range of 1 to 500 nm.

In accordance with an embodiment of the invention, the intermediate layer is formed to have a thickness in the range of 0.03 to 2 μm.

In accordance with an embodiment of the invention, the electrode is an electrode pattern or an electrode wiring.

In accordance with an embodiment of the invention, the electrode pattern is formed in a mesh shape.

According to another preferred embodiment of the present invention, there is provided a display device including a display panel displaying an image, a housing receiving the display panel, and the touch sensor disposed on the display panel and formed as described above.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a plan view showing a touch sensor, in accordance with an embodiment of the invention.

FIG. 2 is a cross-sectional view taken along a line I-I′ of FIG. 1, in accordance with an embodiment of the invention.

FIG. 3 is an enlarged view of a region A of FIG. 2, in accordance with an embodiment of the invention.

FIG. 4 is a view showing a diffusion coefficient according to a temperature of a metal of a diffusion barrier, in accordance with an embodiment of the invention.

FIG. 5 is an exploded perspective view showing a display device including a touch sensor, in accordance with an embodiment of the invention.

FIG. 6 is graph obtained by comparing changes in sheet resistances of electrodes which are manufactured according to an example of an embodiment of the invention and a comparative example.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

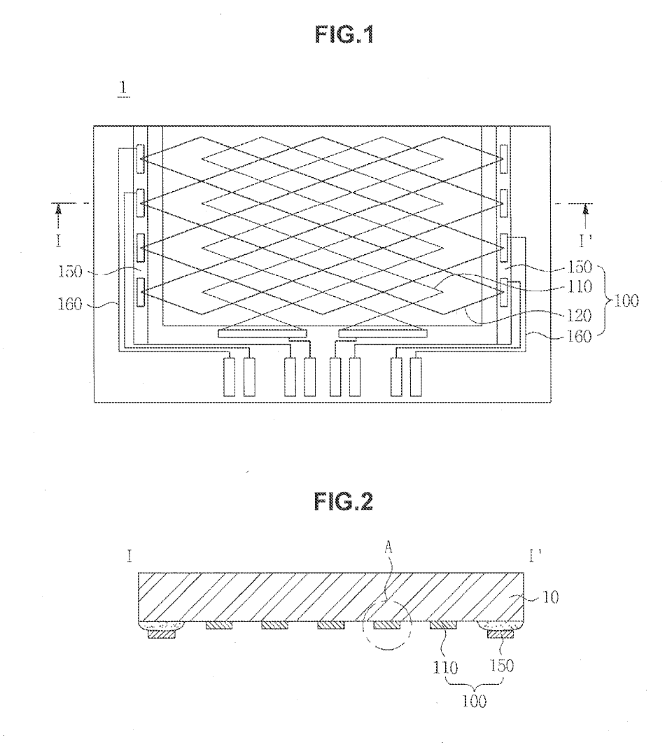

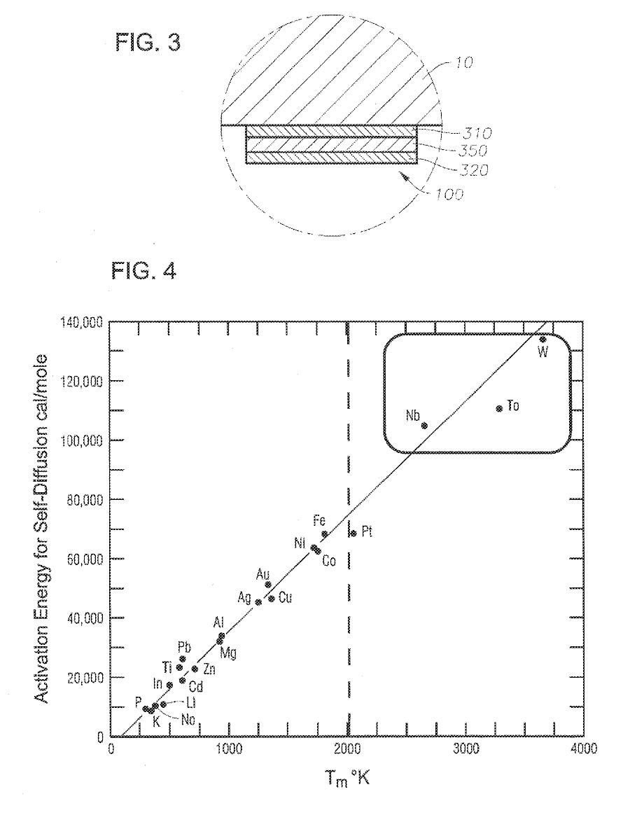

FIG. 1 is a plan view showing a touch sensor, in accordance with an embodiment of the invention, FIG. 2 is a cross-sectional view taken along a line I-I′ of FIG. 1, in accordance with an embodiment of the invention, and FIG. 3 is an enlarged view of a region A of FIG. 2, in accordance with an embodiment of the invention. In other words, FIG. 2 shows a portion of a touch sensor.

Referring to FIGS. 1 and 2, a touch sensor 1 according to an embodiment of the invention includes a first mesh electrode 110 formed on a substrate 10 in a mesh shape and a second mesh electrode 120 formed in the mesh shape to be intersected with the first mesh electrode 110. A first electrode wiring 150 and a second electrode wiring 160 connected to the first mesh electrode 110 and the second mesh electrode 120, respectively, are formed to be extended. The first and second electrode wirings 150 and 160 are formed on a bezel region, which is a non-display region.

In accordance with an embodiment of the invention, the above-mentioned first mesh electrode 110 and the first electrode wiring 150, and the second mesh electrode 120 and the second electrode wiring 160 are integrally formed and are connected to each other by further including a connection electrode between the mesh electrodes 110 and 120 and the electrode wirings 150 and 160. Here, the first mesh electrode 110 is an X axis electrode and the second mesh electrode 120 is a Y axis electrode.

As such, the first and second mesh electrodes 110 and 120 are collectively referred to as an electrode pattern and the first and second electrode wirings 150 and 160 are collectively referred to as an electrode wiring. In addition, the electrode pattern and the electrode wiring are collectively referred to as an electrode 100. In accordance with an embodiment, the above-mentioned touch sensor 1 is formed on a window substrate and is formed on an insulating film depending on a scheme of arranging the electrode 100.

The substrate 10 according to an embodiment of the present invention is made of a material having support force capable of supporting the electrode 100 and transparency capable of allowing a user to recognize an image provided by a display.

In accordance with an embodiment of the invention, the substrate 10 is made of any one selected from the group consisting of polyethylene terephthalate (PET), polycarbonate (PC), poly methyl methacrylate (PMMA), polyethylene naphthalate (PEN), polyethersulphone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), and glass or tempered glass, but is not necessarily limited thereto.

In accordance with an embodiment of the invention, the electrode 100 has line widths and formed thicknesses which are different from each other of the electrode pattern and the electrode wiring. For example, in accordance with at least one embodiment, the line width of the electrode pattern is formed in the range of 0.05 to 3 μm, and the thickness thereof is formed in the range of 1 to 5 μm. In addition, the thickness of the electrode wiring is formed to have a size larger than or equal to the thickness of the electrode pattern.

Referring to FIG. 3, the touch sensor 1 includes the electrode 100 formed on the substrate 10, wherein the electrode 100 includes a first diffusion barrier 310 formed on the substrate 10, an intermediate layer 350 formed on the first diffusion barrier 310, and a second diffusion barrier 320 formed on the intermediate layer 350.

In accordance with an embodiment of the invention, the intermediate layer 350 is made of any one selected from the group consisting of copper (Cu), gold (Au), silver (Ag), aluminum (Al), and an alloy containing at least one of them. Here, since it is preferable to form the intermediate layer 350 by copper in view of cost and conductivity, the intermediate layer 350 made of copper will be exemplarily described.

In accordance with an embodiment of the invention, the first and second diffusion barriers 310 and 320 are made of a transition metal. In addition, the first and second diffusion barriers 310 and 320 are made of one selected among the transition metals having a melting point of 2000° C. or more. For example, in accordance with an embodiment of the invention, the first and second diffusion barriers 310 and 320 are made of any one selected from the group consisting of manganese (Mn), niobium (Nb), molybdenum (Mo), ruthenium (Ru), hafnium (If), tantalum (Ta), tungsten (W), iridium (Ir), and an alloy containing at least one of them.

In accordance with an embodiment of the invention, the first diffusion barrier 310 and the second diffusion barrier 320 are made of the same material as each other and the first diffusion barrier 310 and the second diffusion barrier 320 are made of different materials.

In accordance with an embodiment of the invention, the transition metal having a low melting point has solubility increased as the temperature is increased, such that copper ions are diffused into the transition metal. Here, the line width and the stacked thickness of the electrodes 100 are further thinned according to the trend toward high integration. In accordance with this trend, the electrode 100 generates more heat and the generated heat may increase a diffusion occurrence probability, because it increases solubility of electrode material forming the electrode 100.

Therefore, in accordance with various embodiments of the invention, the diffusion degrades performance of the electrode 100, thereby degrading reliability of the touch sensor 1. Therefore, the diffusion is prevented by using the metal capable of having strong resistance to heat as the diffusion barriers 310 and 320.

As such, the intermediate layer 350 is interposed between the first and second diffusion barriers 310 and 320 having the melting point of 2000° C., thereby making it possible to prevent copper ions of the intermediate layer 350 from being diffused into the contact material.

Therefore, in order to prevent the diffusion of copper ions in the intermediate layer 350, the first and second diffusion barriers 310 and 320 are formed to have a predetermined thickness. For example, in accordance with an embodiment of the invention, the first diffusion barrier 310 is formed to have the thickness in the range of 1 to 500 nm. In addition, the second diffusion barrier 320 is formed to have the thickness in the range of 1 to 500 nm. In addition, the intermediate layer 350 interposed between the first diffusion barrier 310 and the second diffusion barrier 320 is formed to have the thickness in the range of 0.03 to 2 μm. In the case in which the thickness of the intermediate layer 350 is less than 0.03 μm, crystallizability is decreased, thereby increasing metal specific resistance of the intermediate layer 350, and thus it is difficult to form the thickness of the intermediate layer 350 to be more than 2 μm using a deposition process by a general sputtering method.

In accordance with an embodiment of the invention, the diffusion between the metal layers are classified into surface diffusion, grain boundary diffusion, and bulk diffusion. These types of diffusion are not limited to only a particular one, and most diffusions occur at an interface between heterogeneous metals and may be made through a grain boundary.

Further, there is diffusivity indicating a degree of diffusion of each metal, wherein diffusivity has a large difference value according to the kind of metal.

The movement of substance may be expressed as in Fick's law, wherein the movement of substance J is expressed by:

$$J = - D \frac{d c}{d x}$$

where, D represents a diffusion coefficient, dc represents a change in concentration, and dx represents a change in position.

As such, the degree of diffusion is proportional to D, and the lower the diffusion coefficient, the lower the occurrence probability of diffusion.

FIG. 4 is a view showing a diffusion coefficient according to a temperature of a metal of a diffusion barrier, in accordance with an embodiment of the invention. In order to avoid an overlapped description, the description will be made by referring to FIGS. 1 to 3.

First, in accordance with certain embodiments of the invention, the diffusion coefficient is expressed by an Arrhenius equation:

D=D₀e^{-Ea/RT}

where, D represents reaction rate specific, T represents an absolute temperature, R represents a gas constant, D₀ represents a frequency coefficient or a frequency factor, and Eₐ represents activation energy. Here, a unit of D₀ is equal to a unit of a rate constant.

Referring to FIG. 4, collisions between adhesive metals, that is, between molecules cause reaction, but only collision having energy with a minimum value Eₐ or more among collisions between molecules may cause the reaction. A ratio of the number of collisions having energy of Eₐ or more is approximately expressed by e^{(-Ea/RT)} by a Boltzmann distribution. That is, when logarithm of the reaction rate plots with respect to a reciprocal number of the absolute temperature, a linear line is formed, and the activation energy Eₐ and the frequency factor D₀ may be obtained from a gradient and an intercept of the linear line.

Therefore, the lower the unique D₀ value of the substance, the lower the D value. Thus, as the substance has a high melting point, the Eₐ value becomes high and the diffusion hardly occurs.

As such, the diffusion barriers 310 and 320 made of the transition metal having the melting point of 2000° C. or more are formed on the upper and lower portion of the intermediate layer 350, having the intermediate layer 350 made of copper therebetween, thereby making it possible to prevent performance degradation of the electrode 100 caused by the diffusion.

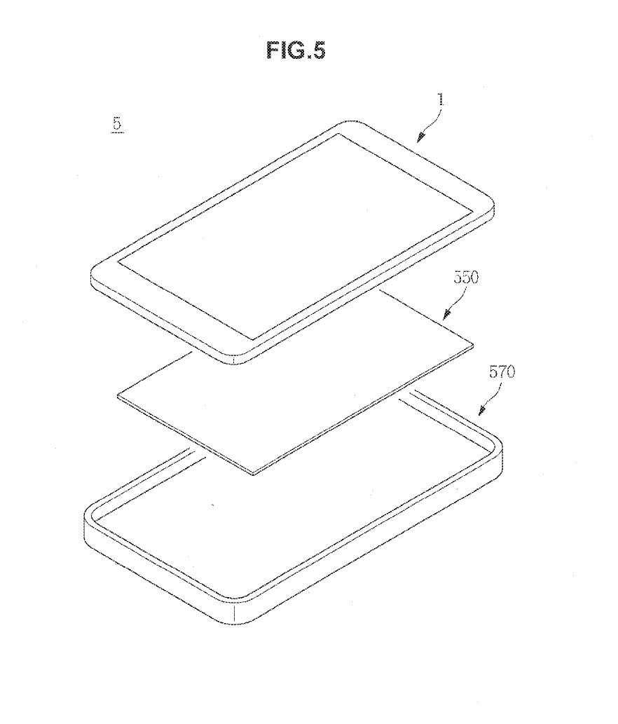

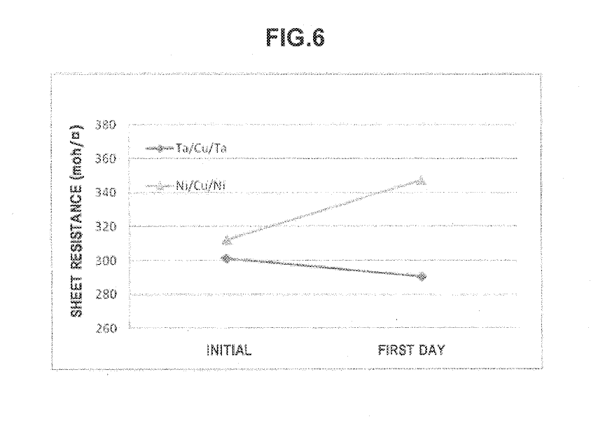

FIG. 5 is an exploded perspective view showing a display device including a touch sensor, in accordance with an embodiment of the invention. Here, the display device including the touch sensor 1 will be described with reference to FIGS. 1 to 4 in order to avoid the overlapped description.

Referring to FIG. 5, the display device 5 according to the preferred embodiment of the present invention includes a display panel 550, a housing 570 receiving the display panel 550, and the touch sensor 1 disposed on the display panel 550. Here, the touch sensor 1 includes an electrode 100, wherein the electrode 100 includes first and second diffusion barriers 310 and 320 and an intermediate layer 350 interposed between the first and second diffusion barriers 310 and 320.

As one embodiment of the present invention, the display device 5 includes various information providing devices such as a television, navigation, a computer monitor, a gaming machine, a mobile phone, as non-limiting examples. Here, for easy description, the mobile phone is exemplarily shown.

In accordance with various embodiments, the display panel 550 displays an image. The display panel 550 includes various display panels such as an organic light emitting display panel, a liquid crystal display panel, a plasma display panel, an electrophoretic display panel, an electrowetting display panel, as non-limiting examples, but is not particularly limited thereto.

In accordance with an embodiment of the invention, the housing 570 receives the display panel 550. Although the housing configured by one member is shown in FIG. 5, the housing 570 is configured by combining two or more members. Alternatively, the housing 570 further receives a circuit substrate having a plurality of active elements (not shown) and/or a plurality of passive elements (not shown) mounted thereon in addition to the display panel 550. Alternatively, the housing 570 may further receive a power source (not shown) such as a battery according to the kind of display device 5.

The touch sensor 1 is disposed on the display panel 550 and is coupled to the housing 570, thereby making it possible to configure an outer surface of the display device 5 together with the housing 570. In this case, the display panel 550 may be coupled to the touch sensor 1.

In accordance with an embodiment of the invention, the touch sensor 1 includes a display region in which an image generated from the display panel 550 is displayed on the plane and a non-display region adjacent to at least a portion of the display region. Here, the non-display region is formed at an edge portion of the display region.

In accordance with an embodiment of the invention, a user views the image displayed on the display device 5 and touches the touch sensor 1, thereby making it possible to input instructions. In this case, the instructions are transferred to a controlling unit by the touch and a transfer signal is transferred by the electrode 100 of the touch sensor 1. In this case, in order to transfer the transfer signal, the electrode 100 needs to have excellent performance.

Since copper used as the electrode 100 has high solubility, silicon ions of the substrate 10 to which the electrode 100 is adhered, and copper ions of adhesive metals to which the electrode 100 is adhered may be diffused. The diffusion of copper ions degrade performance of the electrode 100, thereby degrading performance of the display device 5.

However, the display device 5 including the touch sensor 1 according to the preferred embodiment of the present invention includes the first and second diffusion barriers 310 and 320 and forms the intermediate layer 350 made of copper between the first and second diffusion barriers 310 and 320, thereby making it possible to prevent the diffusion of copper ions.

Therefore, the diffusion of copper ions is prevented, such that corrosion and performance degradation of the electrode 100 are prevented, thereby making it possible to more stably operate the touch sensor 1.

Hereinafter, examples of various embodiments of the invention will be described in more detail, but the scope of these embodiments is not limited thereto.

### Example

A Ta layer having a thickness of 20 nm was deposited on a PET film having a thickness of 100 μm using a DC pulsed sputtering method, a Cu layer having a thickness of 100 nm, which is an intermediate layer, was deposited on the Ta layer, and the Ta layer having a thickness of 60 nm was finally deposited on the Cu layer, such that a sample is finished.

### Comparative Example

A Ni layer having a thickness of 20 nm was deposited on a PET film having a thickness of 100 μm using a DC pulsed sputtering method, a Cu layer having a thickness of 100 nm, which is an intermediate layer, was deposited on the Ni layer, and the Ni layer having a thickness of 60 nm was finally deposited on the Cu layer, such that a sample is finished.

After initial sheet resistances of the samples which are manufactured through the above-mentioned Example and Comparative Example are measured with a 4 point probe, changes in the sheet resistances were measured with the 4 point probe after the samples were put in a chamber and one week passes under conditions of environment reliability having temperature of 85° C. and humidity of 85%. Results thereof are shown in the following Table 1.

TABLE 1

| | Initial Sheet | First Day Sheet |
|---|---|---|
| | Resistance (moh/ [symbol] ) | Resistance (moh/ [symbol] ) |
| Sample of Example | 301.5333 | 290.8 |
| (Ta/Cu/Ta) | | |
| Sample of Comparative | 312.3333 | 347.6 |
| Example (Ni/Cu/Ni) | | |

Referring to Table 1 and FIG. 6, which is a graph obtained by comparing changes in sheet resistances of electrodes which are manufactured according to Example and Comparative Example, as a result obtained by comparing the changes in the sheet resistances under conditions of environment reliability having temperature of 85° C. and humidity of 85%, in the case of the sample of Ni/Cu/Ni, it may be appreciated that a change rate of sheet resistance is increased by about 11%, where the reason is that the Ni layer does not effectively prevent diffusion of Cu ions. On the other hand, in the case of the sample of Ta/Cu/Ta, it may be appreciated that the first day sheet resistance is decreased as compared to the initial sheet resistance. The reason is that the Ta layer completely performs a diffusion prevention function to prevent diffusion of Cu ions and at the same time, as Cu crystal is increased under the conditions of environment reliability of temperature of 85° C. and humidity of 85%, a grain boundary is decreased.

According to the preferred embodiment of the present invention, corrosion of the intermediate layer and performance degradation caused by diffusion is prevented by forming the intermediate layer on the first diffusion barrier contacting the substrate and forming the second diffusion barrier on the intermediate layer.

In addition, performance degradation caused by diffusion is prevented using the diffusion barriers disposed on the upper and lower portions of the intermediate layer, such that operation reliability may be improved, thereby making it possible to more stably operate the touch sensor.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

As used herein, terms such as “first,” “second,” “one side,” “the other side” and the like are arbitrarily assigned and are merely intended to differentiate between two or more components of an apparatus. It is to be understood that the words “first,” “second,” “one side,” and “the other side” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a substrate; and
an electrode on the substrate,
wherein the electrode includes:
a first diffusion barrier contacting the substrate;
an intermediate layer formed on the first diffusion barrier; and
a second diffusion barrier formed on the intermediate layer.

2. The touch sensor as set forth in claim 1, wherein the first and second diffusion barriers are made of a transition metal.

3. The touch sensor as set forth in claim 1, wherein the first and second diffusion barriers are made of a metal having a melting point of 2000° C. or more.

4. The touch sensor as set forth in claim 1, wherein the first and second diffusion barriers are made of any one selected from the group consisting of manganese (Mn), niobium (Nb), molybdenum (Mo), ruthenium (Ru), hafnium (Hf), tantalum (Ta), tungsten (W), iridium (Ir), and an alloy containing at least one of them.

5. The touch sensor as set forth in claim 1, wherein the first diffusion barrier and the second diffusion barrier are made of the same material as each other.

6. The touch sensor as set forth in claim 1, wherein the first diffusion barrier and the second diffusion barrier are made of different materials.

7. The touch sensor as set forth in claim 1, wherein the intermediate layer is made of any one selected from the group consisting of copper (Cu), silver (Ag), gold (Au), aluminum (Al), and an alloy of at least one of them.

8. The touch sensor as set forth in claim 1, wherein the substrate is a window substrate or an insulating film.

9. The touch sensor as set forth in claim 1, wherein the substrate is made of any one selected from the group consisting of polyethylene terephthalate (PET), polycarbonate (PC), poly methyl methacrylate (PMMA), polyethylene naphthalate (PEN), polyethersulphone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), and glass or tempered glass.

10. The touch sensor as set forth in claim 1, wherein the electrode is formed to have a line width in the range of 1 to 5 μm.

11. The touch sensor as set forth in claim 1, wherein the electrode is formed to have a thickness in the range of 0.05 to 3 μm.

12. The touch sensor as set forth in claim 1, wherein the first diffusion barrier is formed to have a thickness in the range of 1 to 500 nm.

13. The touch sensor as set forth in claim 1, wherein the second diffusion barrier is formed to have a thickness in the range of 1 to 500 nm.

14. The touch sensor as set forth in claim 1, wherein the intermediate layer is formed to have a thickness in the range of 0.03 to 2 μm.

15. The touch sensor as set forth in claim 1, wherein the electrode is an electrode pattern or an electrode wiring.

16. The touch sensor as set forth in claim 16, wherein the electrode pattern is formed in a mesh shape.

17. A display device, comprising:
a display panel displaying an image;
a housing receiving the display panel; and
the touch sensor disposed on the display panel and as set forth in claim 1.
